(19) United States
(12) Patent Application Publication
(10) Pub. No.: US 2018/0037702 A1
(43) Pub. Date: Feb. 8, 2018

(54) IONIC-LIQUID MEDIATED PRODUCTION OF CELLULOSE NANOCRYSTALS DIRECTLY FROM WOOD, GRASS OR BIORESIDUES

(71) Applicant: ALBERT LUDWIGS UNIVERSITÄT FREIBURG, Freiburg (DE)

(72) Inventors: Marie Pierre LABORIE, Freiburg (DE); Hatem ABUSHAMMALA, Freiburg (DE)

(21) Appl. No.: 15/551,237

(22) PCT Filed: Mar. 4, 2016
(86) PCT No.: PCT/EP2016/054688

§ 371 Date: Aug. 15, 2017

(30) Foreign Application Priority Data
Mar. 5, 2015 (EP) 15157695.6

(51) Int. Cl. C08H 8/00; B01J 31/02

(52) U.S. Cl. CPC C08H 8/00; B01J 31/0284

(57) ABSTRACT

A process for the production of cellulose nanocrystals directly from wood, grass or bioresidues wherein the wood is treated with an ionic liquid and novel cellulose nanocrystals obtained by the process.

The present invention relates to the ionic liquid mediated production of cellulose nanocrystals directly from wood, grass or a bioresidue comprising mainly cellulose and lignin.

Cellulose nanocrystals (CNCs), rod like nanoparticles, have shown a great potential in a wide range of applications due to their high mechanical properties, low density, and biodegradability. CNCs are traditionally extracted by hydrolysis of cellulosic materials with strong acids in yields ranging from 20 to 60%.

While CNCs are commonly produced from pure cellulosic materials such as wood pulp or microcrystalline cellulose, approaches for extracting CNCs from more complex lignocellulosic biomass have also been investigated.

Mathew et al. (Materials Lett. 71, 28-31 (2012), Industrial Crops and Products, 58, 212-219 (2014), Biomass and Bioenergy 35(1), 146-152 (2011)) converted a cellulosic-rich residue of wood bioethanol production into CNCs by successively conducting mild acid hydrolysis, bleaching and high pressure homogenization.

WO2011/072365 discoses an inorganic persulfate treatment of vegetable biomass for producing CNCs. According to the process, the cellulosic material is contacted with an inorganic persulfate at elevated temperatures.

In WO 2011/072365, the starting lignocellulosic material had a low lignin content as either a delignified residue or as a naturally low lignin-content (5-7%) hemp fiber. In lignocellulosic biomass, lignin is particularly recalcitrant to removal due to its bonding to heteropolysaccharides in lignin-carbohydrate complexes (LCCs) and its maintained reactivity and propensity for condensations stemming from its phenolic hydroxyls. Wood comprises a high lignin content, ranging from 20 to 40 wt %.

Ionic liquids (ILs) have been successfully used for multiple purposes including complete dissolution of wood and sugar recovery and delignification and recovery of cellulose.

The interaction of ionic liquids with wood structural polymers can be modulated based on the hydrophilicity/hydrophobicity, and acidity/basicity of their constituting ions and viscosity of the ionic liquid.

Among ILs used with lignocellulose, 1-ethyl-3-methylimidazolium acetate ([EMIM][OAc]) is known to display a certain degree of specificity for lignin dissolution (Brandt, Hallett, Leak, Murphy & Welton, Green Chemistry 12(4), 672-679 (2010); Hauru et al., RSC Advances, 3(37), 16365-16373 (2013); Hossain & Aldous, Austr. J. Chem. 65(11), 1465-1477 (2012); Lee, Doherty, Linhardt & Dordick, Biotechnology and bioengineering 102(5), 1368-1376 (2009)). It has been utilized for ionic liquid-assisted fractionation (ILAF) of wood under homogeneous conditions thereby producing a cellulose II pulp (Sun, Rahman, Qin, Maxim, Rodriguez & Rogers, Green Chemistry 11(5), 646-655 (2009). Its potential for heterogeneous ILAF to recover a native cellulose I pulp has also been proposed in Hauru et al (see above). Moreover, [EMIM][OAc] has been shown to hydrolyze cellulose under mild conditions.

The direct extraction of CNCs from wood, grass or bioresidues comprising mainly cellulose and lignin, which would provide a number of advantages has not been demonstrated until today.

Therefore, an ongoing need exists for a technology to directly extract CNCs from woodgrass or bioresidues comprising mainly cellulose and lignin. Such a technology should simultaneously induce i) wood delignification, ii) hydrolysis of cellulose amorphous regions in situ while iii) leaving cellulose native crystalline regions intact.

Acetate ILs have a high affinity to lignin dissolution (Lee et al., Biotechnology and Bioengineering 2009, 102(5), 1368-1376).

It was thus an object of the present invention to provide a process for the ionic liquid mediated production of cellulose nanocrystals directly from wood, grass or bioresidues comprising mainly cellulose and lignin and to provide novel cellulose nanocrystals obtainable in accordance with the said process.

This object is achieved with the process in accordance with claim 1 and the cellulose nanocrystals in accordance with claims 9 and 10

Preferred embodiments of the invention are set forth in the dependent claims and the detailed specification hereinafter.

According to the process of the invention, wood, grass or a bioresidue comprising mainly cellulose and lignin is treated with an ionic liquid at a temperature of 85° C. or less, preferably 75° C. or less and even more preferably 70° C. or less for a period of from 1 minute to 12 hours, preferably for a period of from 1 minute to 8 hours and even more preferably for a time period of from 1 minute to 6 hours.

The weight ratio of wood, grass or bioresidue to the ionic liquid is not subject to any particular limitation but is generally in the range of from 1:50 to 50:1, preferably in the range of from 1:10 to 1:40.

In some cases treatment temperatures of 40° C. or less have proven to be very effective at short treatment times of less than ten minutes, even as low as one to three minutes. This has in particular been seen in the treatment of bioresidues.

The term wood, when used herein, is intended to denote native or bulk wood as well as powdered wood (such as e.g. sawdust), pelletized wood or wood chips, i.e. wood in any physical form may be used. Accordingly, the process in accordance with the present invention allows to valorize products which are usually considered as waste (e.g. saw dust)

The term grass, when used herein, is intended to denote plants that have narrow green leaves, that are eaten by cows, sheep, horses, etc., and/or that are commonly grown on lawns and in gardens. Alfalfa may be mentioned as only one example.

The term bioresidue, when used herein, is intended to denote a composition of matter comprising mainly cellulose and lignin. Comprising mainly means that these two components comprise more than 50, preferably more than 60 and even more preferably more than 75 wt % of the bioresidue. Most preferred are compositions comprising 85 wt % or more of the two components cellulose and lignin. The term cellulose, when used in conjunction with the bioresidue, encompasses cellulose type I as well as cellulose type II and hemicelluose; it is preferred however if the majority of the cellulose is constitued by cellulose type I.

The ratio of cellulose to lignin is not subject to particular limitations and may be in the range of from 1:3 to 10:1, preferably in the range of from 1:3 to 3:1 and even more preferably in the range of from 1:2 to 2:1.

Additional components present in the bioresidue preferably constitute less than 25, preferably less than 15 wt % and are usually mainly extractives which can be removed by extraction.

In some cases a treatment at a temperature of 60° C. or less for a period of 2 hours or even less has shown good results.

It has also proven advantageous in certain cases, in particular if bulk or pelletized wood is the substrate, if the treatment is carried out in at least two successive cycles under the conditions described before.This increases the degree of lignin removal and the removal of amorphous cellulose components which are present in the wood while providing a good recovery of the crystalline nanocellulose.

The nature and type of wood which may be used in accordance with the process of the present invention is not subject to any particular limitation and therefore principally any type of wood (hardwood or softwood) in any physical form, as mentioned above, may be used as a starting material. In some cases excellent results have been obtained with Angelim vermelho (Dinizia excelsa) wood from the Amazonian rain forests or Norway Spruce, to name only two representatives of suitable woods.

In accordance with a preferred embodiment of the process in accordance with the present invention, the wood, grass or bioresidue may be subjected to a dewaxing step prior to the treatment with the ionic liquid. Such dewaxing treatments are known to the skilled person and he or she will select the appropriate conditions for the dewaxing based on his or her professional experience.

The nature of the anion and the cation of the ionic liquid (IL) used in the process in accordance with the present invention have an influence on the efficiency of the process and the degree of recovery of the desired CNC.

In general, ILs with imidazole based cations have proven to be advantageous in many cases. The imidazole may be substituted or unsubstituted and substituted imidazolium ILs may have one or more than one substituent at the imidazole ring. The nature of substituents at the imidazole ring system is normally not of critical importance and thus any substituent known to the skilled person in ionic liquids based on imidazoles may be used. Just by way of example, alkyl groups may be mentioned here.

In some cases ionic liquids with acetate as anion have proven to be advantageous but it is also possible to use ILs with other anions. The skilled person will select the best suited anion based on his or her professional experience and taking into account the specific application case.

In some cases 1-ethyl-3-methylimidazolium acetate [EMIM][OAc] or 1-butyl-3-methylimidazolium acetate [BMIM][OAc] have proven to be particularly suitable ILs for the treatment of wood, grass or bioresidues in accordance with the present invention.

The process in accordance with the present invention allows to obtain products containing high amounts (up to 90%) native (crystalline) cellulose in a yield of from 20 to 95, preferably of from 22-95% with respect to the cellulose content of the wood, grass or the bioresidue.

Analysis of the products which can be obtained in accordance with the process of the present invention in some cases evidenced the presence of partially acetylated nanocrystals of native cellulose I microstructure, with a crystallinity index of more than 60%, preferably from 70-75% and an aspect ratio in the 22-90, preferably in the 44-85 range.

In the process according to the present invention, a rather low temperature allows to prevent the ionic liquid from dissolving cellulose while maintaining its dissolution power on hemicelluloses and lignin. Such efficient pulping process with one IL reactant to recover native cellulose was not known before. The low temperature and the presence of residual lignin or stress appear to be important for maintaining a cellulose I morphology. At the same time cellulose hydrolysis easily takes place on a swollen cellulose as evidenced with the decrease in DP of the final cellulosic products down to the level-off DP of ca. 300. Overall, the process in accordance with the present invention allows Ionic liquid fractionation under heterogeneous conditions; in other words lignin is indeed dissolved while cellulose is maintained under swollen conditions, conditions under which it is easily amenable to chemical reaction (hydrolysis, acetylation).

Partial cellulose acetylation has been observed in many cases (see Examples) where [EMIM][OAc] operated at low temperature (60° C.) and in apparent absence of a catalyst.

In many cases, no acetylation or a low degree of acetylation was detected after a first pulping cycle. The acetylation seemed to take place only or predominantly during a second or subsequent cycle. This might be an indication that the first cycle mainly involved the dissolution of wood polymers outside the bulk cellulosic component. The dissolved wood lignin and hemicelluloses might have undergone acetylation but acetylation remained undetected on the solid residue. In the second cycle, the more exposed cellulose, still intimately bound to residual lignin, was again subjected to treatment with the IL. Acetylation on lignin and cellulose and trans-acetylation between them might have occurred. In all cases, we assume—without being bound by theory—that heterogeneous cellulose acetylation most likely occurred in this second pulping cycle and that it was strongly mediated by a catalyst (residual lignin) (Köhler et al., Macromolecular Rap. Comm. 28 (24), 2311-2317 (2007)).

It may be assumed that lignin and cellulose acetylation contribute to the facile fractionation of wood, grass or bioresidue into its individual polymers. Lignin acetylation blocks its hydroxyl groups, which is otherwise necessary for lignin condensations. As lignin condensation reactions are a major challenge for its complete removal during pulping, by blocking lignin reactivity acetylation likely facilitates the separation of lignin from other wood constitutive polymers.

The surface degree of acetylation (DA) of CNCs obtained in accordance with the process of the present invention is usually in the range of from 3 to 40%, preferably of from 4 to 30% (ca. 22% and 4.2% in the working examples 1 and 2, respectively). This represents a significant surface modification, which likely alters the colloidal and surface interactions of the forming cellulosic particles. Supporting evidence to this proposition is found in the measured water contact angle of CNC pellets, which increased from 42.1° on untreated cellulose to 51.7° on the actual CNCs extracted with [EMIM][OAc] in working example 1. As acetylation proceeds, cellulose becomes less hydrophilic and thus less prone to intermolecular interactions via H-bonds. Combined with the acidic potential of the imidazolium cation, glycosidic hydrolysis apparently occurs between crystallite regions and liberates the CNCs.

In some cases with wood as substrate advantages have been observed if the wood was subjected to a so-called steam explosion pulping prior to the treatment with the ionic liquid in accordance with the present invention. Explosion pulping for the purpose of the present invention denotes an ultra-high-yield pulping process based on short time vaporphase cooking at temperatures usually in the range of 80 to 210° C., followed by (explosive) decompression. Details on suitable explosion pulping conditions can be found in Kokta et al., “Steam Explosion Pulping” in “Environmentally friendly technologies for the pulp and paper industry”, Editors Raymond A. Yound and Masood Akhtar, Wiley 1998) to which reference is made here for further details. Example 3 shows the results of such a combination. It has been observed that in particular high aspect ratios for the cellulose nanocrystals could be obtained by this combination of steam explosion pulping and the treatment with the ionic liquid in accordance with the present invention..

The process of the present invention thus provides a novel ionic liquid-based procedure to simultaneously pulp wood, grass and bioresidues and liberate its cellulose as nanocrystals.

The acetate ionic liquid [EMIM][OAc] was tailored towards the isolation of native cellulose pulp with a crystallinity of ca. 70%. More importantly, 40-60% of the produced pulp existed in the form of cellulose nanocrystals, which were easily extracted upon dispersion in water.

The cellulose nanocrystals obtainable in accordance with the process of the present invention are novel and constitute another embodiment of the invention.

Preferably the cellulose nanocrystals in accordance with the present invention have a number average diameter of from 2 to 4 nm (this diameter denotes the diameter value below and above of which 50% of the individual fibers are situated) with more than 90% of the nanocrystals usually having a diameter below 5 nm and an aspect ratio of from 20 to 100, preferably of from 40 to 90. There is nearly no diameter increase (in many cases less than 20% or even less than 10%) compared to the cellulose crystallites present in the original wood or the bioresidue. Cellulose nanocrystals obtained by classical treatment processes for the pulping of wood normally yield crystals with a lower aspect ratio due to a significant increase in the diameter of the nanocrystals during the treatment. This is not the case to a significant extent in the process according to the present invention.

The aspect ratio of a geometric shape is the ratio of its sizes in different dimensions; in the present case and for the purpose of the present invention it denotes the ratio of length to the number average diameter of the cellulose nanocrystals.

Methods for determining number average diameter and length of the cellulose nanocrystals are known per se and have been described in the literature. Scanning electron microscopy and diffraction methods as well as atomic force microscopy may be mentioned here. The skilled person will select a suitable method based on his professional experience.

As mentioned above, it has proven to be advantagoeus if the cellulose nanocrystals in accordance with the present invention comprise a certain content of lignin which is coating the surface of the cellulose. The preferred content of lignin is of from 5 to 40 wt %, preferably of from 10 to 30 wt %, based on the combined weight of cellulose and lignin.

The lignin in many cases is predominantly or exclusively attached to the surface of the cellulose nanocrystals through physical adhesion and not through covalent bonding. It is possible, however, that chemical or covalent bonding may occur in some cases in addition to or instead of physical adherence.

The amount of lignin present usually covers appr. 10 to 60%, preferably of from 15 to 50 and most preferably of from 20 to 40% of the surface area of the cellulose nanocrystals.

The cellulose nanocrystals containing lignin in accordance with the present invention can be advantageously used in a number of applications in the polymer composite field or may themselves be useful for certain applications cellulose nanocrystals without lignin may not be suited.

Brief description of the figures.

All figures relate to the product obtained in Example 1.

FIG. 1. shows Fourier-Transform Infrared (FT-IR) spectra of untreated wood (WR-0), wood residues after a first (WR-1) and second (WR-2) IL-pulping cycle and after a successive bleaching step (WR-2-B).

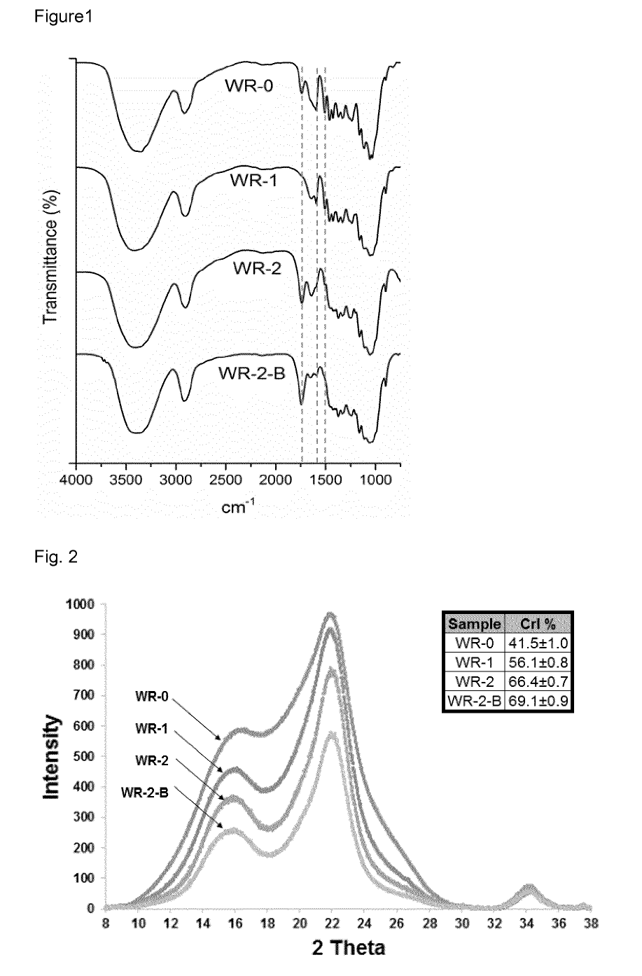

FIG. 2 shows the X-ray diffraction pattern of untreated wood (WR-0) and wood residues (WR-1, WR-2, and WR-2-B), illustrating the increase in apparent cellulose crystallinity index and preservation of cellulose I morphology upon pulping with [EMIM][OAc].

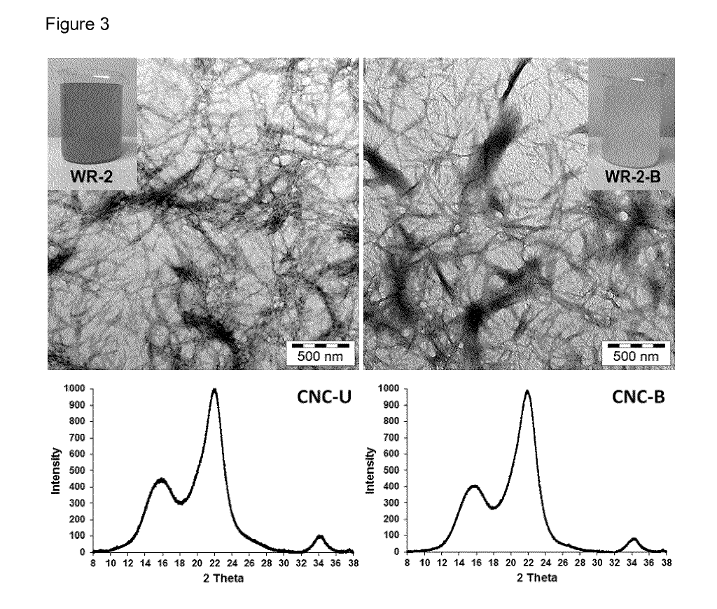

FIG. 3. shows transmission electron microscopic (TEM) images and wide angle X-ray (WAX) diffractograms for the supernatant of unbleached (WR-2) and bleached (WR-2-B) pulps evidencing the production of cellulose I nanocrystals.

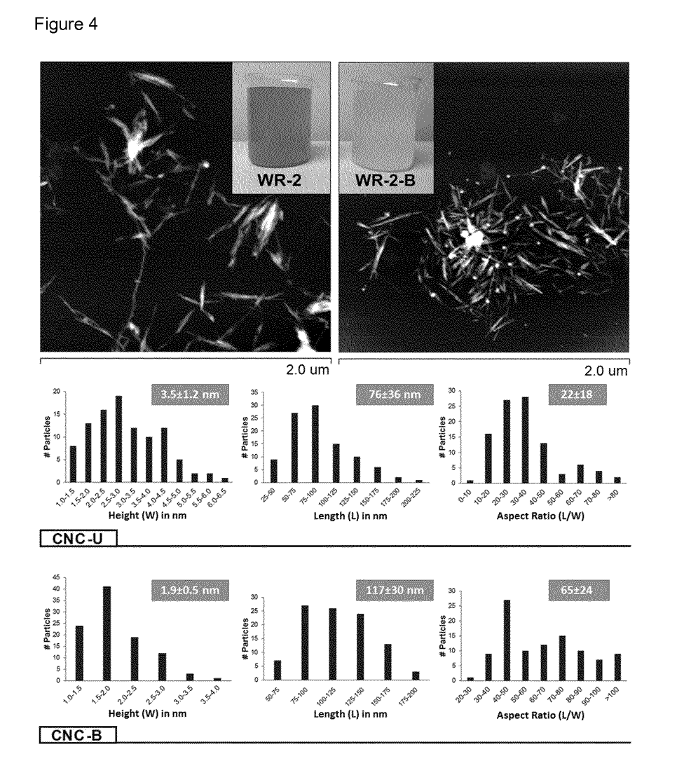

FIG. 4. shows atomic force microscopy (AFM) height images for the supernatant of the unbleached (CNC-U, left) and bleached cellulose nanocrystal particles (CNC-B, right) and the respective distribution of lateral dimension (W), length (L) and aspect ratio (L/W) of the particles.

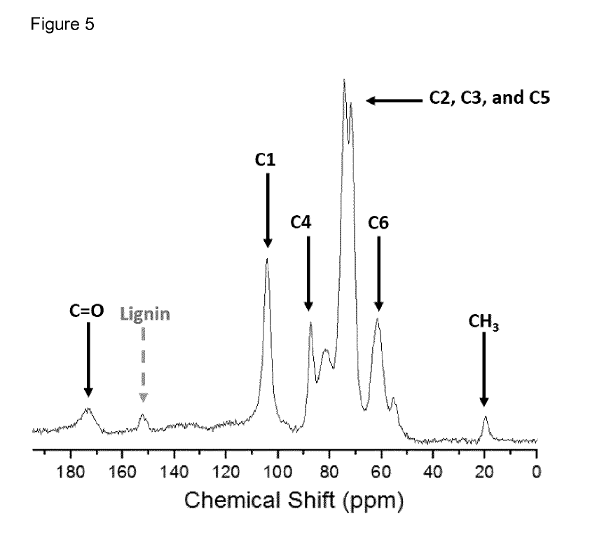

FIG. 5. shows ¹³C CP/MAS (cross polarizing magic angle spinning) NMR of the bleached cellulose nanocrystals (CNCs).

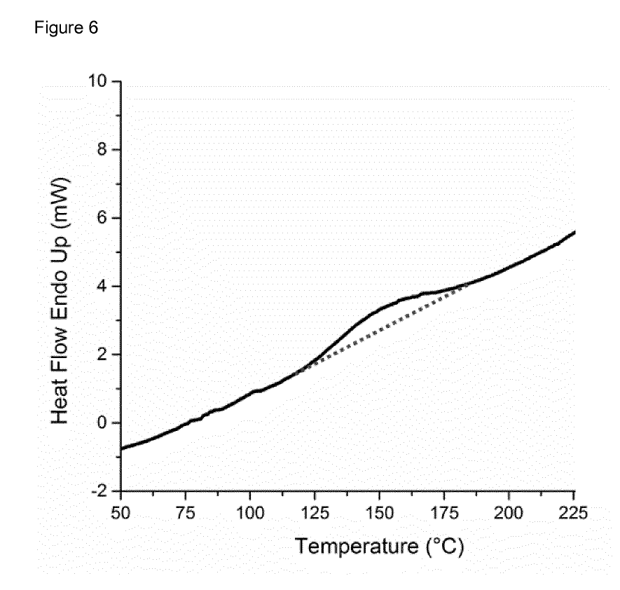

FIG. 6 shows the differential scanning calorimetry (DSC) of the bleached nanocrystals (CNC-B). The measurement was performed in nitrogen environment under a heating rate of 10° C./min.

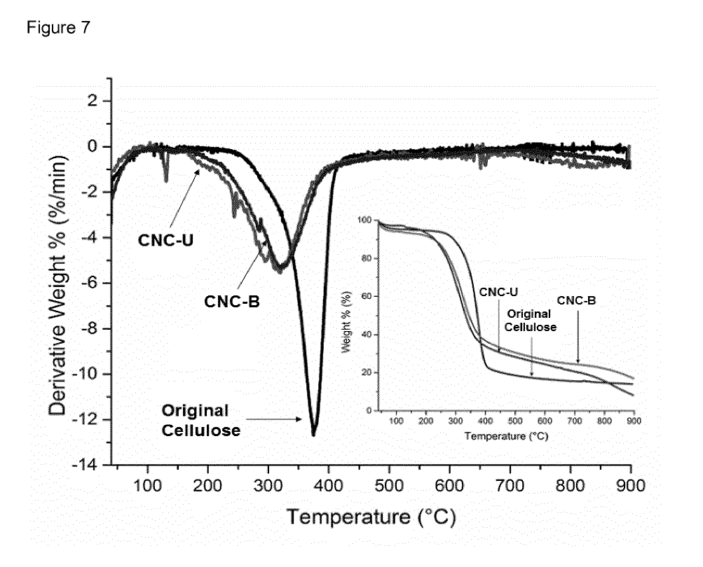

FIG. 7 shows theTGA (thermal gravimetric analysis) of the bleached and unbleached nanocrystals compared to the original cellulose. The measurement was performed in nitrogen environment under a heating rate of 10° C./min.

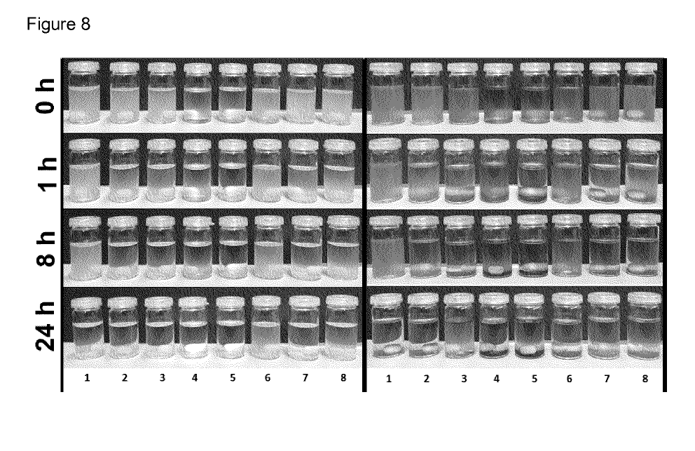

FIG. 8 shows the dispersability of the bleached (Left) and unbleached cellulose (Right) nanocrystals in various organic and inorganic solvents. The solvents are: (1) water, (2) Acetic Acid, (3) THF, (4) DMSO, (5) Toluene, (6) Chloroform, (7) Ethanol, and (8) Acetone

### EXAMPLES

Materials

Angelim vermelho (Dinizia excelsa) wood from the Amazonian rain forests was milled to 150 μm particle size using disc mill RS 200 (Retsch, Düsseldorf, Germany) and dewaxed with an ethanol:acetone:toluene mixture (1:1:4 volume ratio) in a soxhlet operating at 120° C. for 8 hours. The dewaxed wood powder (ca. 9% mass loss) was then washed with hot water and oven dried overnight at 60° C. under vacuum and kept in a vacuum desiccator until use.

1-ethyl-3-methylimidazolium acetate [EMIM][OAc], acetyl bromide, hydroxylamine hydrochloride, hydrogen peroxide, alkali lignin, alpha-cellulose, pyridine, phenyl isocyanate, sodium hydroxide, phenolphthalein, sodium chlorite were purchased from Sigma-Aldrich. Acetone, ethanol, toluene, chloroform, dimethyl sulfoxide, acetic acid, tetrahydrofuran, methanol, hydrochloric acid were purchased from VWR.

### Example 1

### Treatment of Angelino Vermelho Wood using [EMIM][OAc]

The following scheme shows the process in accordance with the present invention followed in the Examples and to the right the mass balance for the two pulping cycles

4.0 g of the extractive-free wood flour (hereinafter referred to as WR-0) was stirred in open atmosphere with 80.0 g of [EMIM][OAc] pre-heated at 60° C. After two hours of mixing, the mixture was centrifuged at 12,000 rpm for 10 minutes (F156×100Y Multifuge, Thermo Scientific, USA), yielding a precipitate and a supernatant. The supernatant (Puping Liquor 1) was decanted into a 200 mL Erlenmeyer flask. The precipitate (Wood Residue 1, WR-1) was washed three times with DMSO and then deionized water to remove residual dissolved wood and residual ionic liquid. It was subsequently oven-dried at 60° C. under vacuum overnight and kept in a desiccator until characterization. In this process, the pulping liquor and the washing eluents (Washing 1) were also generated and collected for analysis (FIG. 1). A second identical treatment using a fresh [EMIM][OAc] was repeated on Wood Residue 1. This second treatment cycle similarly generated 3 fractions, named Wood Residue 2 (WR-2), Pulping Liquor 2, and Washing 2 WR-2 was further bleached with 5% H₂O₂ at 60° C. for 2 hours, washed with deionized water and oven-dried at 60° C. under vacuum to generate a Bleached Wood Residue 2 (WR-2-B).

The pulping liquors and washings of the two treatment cycles were separately treated to collect and fractionate the dissolved wood polymers. Each pulping liquor was mixed with an equivalent weight of 52% (w/w) acetone/water solution as anti-solvent. A brownish material was precipitated and filtered off (Polysaccharide-Rich Residue). The filtrate was diluted with water and kept for one day to settle down. Another brown material was precipitated and filtered off (Lignin-Rich Residue). The washings were treated differently. Water was added as antisolvent to precipitate the dissolved wood particles. The precipitate was filtered off and oven-dried (Washing Residue). The ionic liquid was collected after distilling the other liquids under vacuum (DMSO at 80° C. and water at 50° C.). All wood fractions were oven-dried under vacuum overnight and weighed for mass balance purposes. Both pulping cycles and subsequent treatments were performed in duplicate to ascertain reproducibility.

The composition of the pulping products was analyzed with traditional wet chemistry method. Lignin content was measured with the method of Foster et al. with some modifications (Foster, Martin & Pauly, Journal of visualized experiments (JOVE (37), 2010). The absorbance of the final solutions was determined using UV spectrophotometer TIDAS (J&M Analytik AG, Germany). The lignin content was then computed from the absorbance of the solution based on a UV calibration curve previously built with wood-milled lignin solutions of known concentrations. The wood-milled lignin was obtained from Angelim vermelho by the method of Björkman (Björkman, Svensk papperstidning 59 (13), 477-485, 1956). Holocellulose and cellulose contents were determined following the method of Ona et al. (Ona, Sonoda, Shibata & Fukazawa, Tappi journal 78, 1995). The extracted cellulose was used as a reference for comparison (CELL-0).

Additionally, FT-IR was performed on KBr pellets comprising 2 mg of sample. Spectra were collected in transmittance mode on a FT-IR spectrometer 65 (Perkin Elmer, USA) using 64 scans at a resolution of 2 cm⁻¹. For elemental analysis, 2 mg of dried material was analyzed on a Vario elemental analyzer (Elementar Analysensysteme GmbH, Germany).

Morphological and Structural Analysis of the Supernatant Obtained from Wood Residues:

Upon redispersing the wood residues (WR-2-B and WR-2) from the second cycle in deionized water, and rapid sonication (30 seconds in ultrasonicater UW 2200, Bandelin Electronic, Germany), a turbid supernatant formed. All turbid supernatant phases from WR-2 and WR-2-B were collected and then subjected to further characterization either directly as a dispersion or after freeze-drying.

Zeta-Potential

The zeta potential of about 0.01% (w/w) supernatant was measured using a Zetasizer Nano-ZS90 (Malvern Instruments Ltd. UK).

Transmission Electron Microscopy (TEM):

A droplet of diluted sample from the supernatants was placed on a carbon-coated TEM grid and allowed to dry overnight at ambient temperature. The sample was observed under TEM (Zeiss LEO OEM 912) operating at an accelerating voltage of 100 kV.

Atomic Force Microscopy (AFM)

A droplet of a diluted sample from the supernatants was allowed to dry overnight on a fresh surface of mica. The sample was then observed in tapping mode with an atomic force microscope (Nanoscope III) equipped with a tube scanner (Veeco Santa Barbara, USA) using silicon tips (PPP-NCH, Nanoandmore, Germany). Resonance frequency of 360 kHz and a spring constant of 50 N.m⁻¹ were used. The particle dimensions (height and length) were assessed using Nanoscope Analysis software (version 1.40) on about 100 particles.

Wide Angle X-Ray Diffraction (WAXD):

A Seifert 3003 TT X-ray diffractometer (General Electric, USA) using CuKα radiation operated at 40 kV and 30 mA was used in transmission. The intensities were collected at 2⊖ angles from 5 to 40°. The crystalline structure was determined using Match! Software (version 1.11c). In the case of cellulose morphology, the apparent crystallinity index (Cr!) was calculated according to Segal's method (Segal, Creely, Martin & Conrad, Textile Research Journal 29 (10), 786-794 (1959)).

Gel Permeation Chromatography (GPC):

The molecular weight and degree of polymerization of the supernatant material were determined on freeze-dried samples after carbanilation with phenyl isocyanate (Hubbell & Ragauskas, Bioresource Technology 101 (19) 7410-7415 (2010)). The gel permeation chromatography system PSS 1200 (Agilent Technologies, USA) was equipped with three styragel columns (PSS SDV 5 μm: 10², 10³, and 10⁴) and ultraviolet (1200 UV 254 nm) and refractive index (Knauer K-2301) detectors. THF was used as a mobile phase (flow rate: 1.0 mL/min) with injection volume of 50 μL and a column temperature of 30° C. The calibration was performed using polystyrene standards (ReadyCal-Kit high, PSS-pskitr1h-04). The reported values of molecular weight and degree of polymerization were the average of duplicate samples.

Cross-Polarization Magic Angle Spinning Carbon Nuclear Magnetic Resonance (¹³C CP MAS NMR):

¹³C CP MAS NMR spectrum of freeze-dried sample of the bleached supernatant was acquired on a Bruker Avance 300 MHz spectrometer (Billerica, Mass., USA) for WR-2.

Contact Angle Measurement:

The contact angle of CNC-B was measured and compared to that of the native wood cellulose (CELL-0) using Digidrop equipment (GBX, France). A 4 μl water droplet was dropped on the cellulose surface and followed by the required tangent procedure.

Results:

In the first cycle, ˜43% of the wood was dissolved leaving ˜57% of the woody material in the form of WR-1. The first pulping cycle resulted in about 69% delignification and 92% removal of hemicelluloses, with cellulose losses <5%. The pulping conditions were therefore well optimized to preferentially dissolve lignin while preserving cellulose. With the second cycle, an additional weight loss of ˜13% was observed. Together, the two cycles resulted in ˜89% delignification, ˜94% removal of hemicelluloses, and ˜16% cellulose degradation (cellulose extraction efficiency ˜84%). A 90% pure cellulose pulp (WR-2) was obtained, which was then largely whitened upon bleaching with hydrogen peroxide. Bleaching resulted in an additional mass loss of ˜9%, corresponding to the residual content of lignin and hemicelluloses. Mass balance was verified by compositional analysis, which confirmed negligible mass losses (<2% for wood polymers). Additionally, over the two cycles 95% of the ionic liquid could be recovered.

FT-IR analysis provided further structural information on the pulping products (FIG. 1). When comparing neat wood before (WR-0) and after one pulping cycle (WR-1), the disappearance of the vibration at 1741 cm⁻¹, which represents the stretching vibration of carbonyl groups in hemicelluloses, suggested efficient dissolution of hemicelluloses during the first pulping cycle. In parallel, the phenolics fingerprint at 1610 cm⁻¹ and 1510 cm⁻¹ are largely reduced after the first cycle (WR-1) and to a lesser extent after the second cycle (WR-2) compared to the initial wood (WR-0), confirming delignification. Elemental analysis (Results shown in Table 1) corroborated this observation.

TABLE 1
Molar elemental analysis of the original wood (WR-0) and wood
residues (WR-1, WR-2, and WR-2-B) corrected to 6 moles of carbon.

| Material | C | H | O | N |
|---|---|---|---|---|
| WR-0 | 6.00 | 9.04 | 4.04 | 0.00 |
| WR-1 | 6.00 | 9.52 | 4.32 | 0.01* |
| WR-2 | 6.00 | 9.73 | 4.76 | 0.01* |
| WR-2-B | 6.00 | 10.15 | 5.11 | 0.01* |

*No significant amount of nitrogen in the wood residues, eliminating the possibility for having significant residual ionic liquid.

Surprisingly, a sharp vibrational peak at 1741 cm⁻¹ characteristic of C=O bonds appears in WR-2 (90% cellulose), suggesting acetylation. The efficiency of pulping was finally evidenced with Wide-Angle X-ray diffraction (WAXS) as wood crystallinity increased upon the two pulping cycles (and after bleaching) while the native cellulose I structure appeared maintained. FIG. 2 shows the X-ray diffraction pattern of the untreated wood (WR-0 and wood residues (WR-1, WR-2, and WR-2-B), illustrating the increase in apparent cellulose crystallinity index and preservation of cellulose I morphology upon pulping with [EMIM][OAc].

Surprisingly, WR-2 and WR-2-B were found to form dispersions in water with short-time stability. The negligible zeta potential measured at 0.0272±2.2 mV and -0.0279±1.9 mV for WR-2-B and WR-2, respectively indicated negligible charge on these products. Over time, the dispersions sedimented and a turbid supernatant formed which was collected and further analyzed. This turbid supernatant amounted to ˜41%±4 and ˜57%±4 of WR-2 and WR-2-B material, respectively.

TEM and WAX diffractograms of WR-2 and WR-2-B supernatant dispersions as shown in FIG. 3 evidenced rod-like nanoparticles for both unbleached and bleached products. The WAXS diffraction patterns for these products exhibit characteristic convoluted peaks of cellulose I at 2⊖ equal to 14.8°, 16.3°, 20.4°, 22.4° and 34.5° corresponding to the crystallographic planes [−110], [110], [102], [200] and [004], respectively. The absence of a diffraction peak at 2⊖ equal to 12°, revealed that cellulose II microstructure was not significantly present. Crystallinity index (Crl) was measured according to the Segal method. It increased from ˜42% in the native wood (WR-0) to ˜70±2 and ˜73±1 for unbleached and bleached supernatant products. Thus, native cellulose nanocrystals are clearly produced by treating wood twice with [EMIM][OAc].

Deconvolution of the WAXS pattern further allowed determining coherence lengths of the crystallites in the lateral and longitudinal directions; thicknesses T were derived from the [200] reflection at 2⊖=22.4° and lengths B from the [004] reflection at 2⊖=34.5° applying the Scherrer equation and with scattering vector q=4π/λsinθ. Cellulose crystallites in WR-0 were T: 2.4 nm; B: 5.4 nm, and T: 2.9 nm; B: 4.6 nm in CNC-B. Crl and CNC widths (heights) are of the same order although slightly smaller to those reported in the literature for CNCs obtained from pulps with sulfuric acid.

As the quality of the TEM images did not allow accurately measuring the nanocrystals dimensions, AFM was utilized to that end despite the known overestimation due to tip-broadening effects (Kvien, Tanem & Oksman, Biomacromolecules 6 (6, 3160-3165 (2005)). AFM of WR-2 and WR2 B material confirmed the presence of cellulose nanocrystals with width ranging from 2 to 5 nanometers and length ranging from 75 to 125 nm as shown in FIG. 4. These nanocrystals exhibit smaller average lateral dimensions than those obtained from pulp or MCC. Interestingly, the nanocrystals appeared significantly longer and thinner after the bleaching step; upon bleaching, the CNCs in the 4.0-6.5 nm range disappeared and thinner (1.0-4.0 nm width) more homogeneous CNCs remained. It is assumed that bleaching liberated residual lignin which bound nanocrystals into stacks and therefore resulted in higher yields (ca. 57% instead of 41%) of thinner nanoparticles. The thinner nanoparticles might be more easily collected in the bleached supernatant even at higher lengths leading to an overall length distribution shift to higher average length.

These evidences for the direct production of cellulose nanocrystals by treating wood with [EMIM][OAc] might be an indication of several concurrent processes. On the one hand, hydrolysis of amorphous cellulose regions apparently concurs with the preservation of cellulose I crystalline morphology. On the other hand, separation of the constitutive wood polymers during IL treatment requires that lignin propensity for condensation during pulping is prevented. These processes were further evaluated with detailed structural analyses of the CNCs.

Evidence of Cellulose Hydrolysis during [EMIM][OAc] Treatment:

While wood original cellulose (CELL-0) had a degree of polymerization (DP) of 3016 (Table 2), a significant decrease in DP to about 300 was measured in the CNCs, demonstrating effective hydrolysis of cellulose with [EMIM][OAc]. This experimentally measured DP for CNCs is in line with the CNCs' length, since in a fully extended chain conformation, 227±60 anhydroglucose units (1.03 nm in length) would be needed to produce 117±30 nm long CNC (Sugiyama, Vuong & Chanzy, Macromolecules, 24 (14), 4168-4175, 1991). It also corresponds to the level-off degree of polymerization of wood cellulose in the 200-300 range (Battista, Coppick, Howsmon, Morehead & Sisson, Industrial and Engineering Chem. 48 (2), 1956).

TABLE 2
Weight average molecular weight (Mw) and degree of
polymerization (DP) of original cellulose (Cell-0) and cellulose in
bleached wood residue (WR-B), and the bleached nanocrystals
(CNC-B) measured from their tricarbanilate derivatives.

| Sample | M_{w} | DP |
|---|---|---|
| Cell-0 | 1,565,450 | 3016 |
| WR-2-B | 162,450 | 313 |
| CNC-B | 169,210 | 326 |

Cellulose hydrolysis is catalyzed by Bronsted acids in the presence of water. The small amount of water in the IL (3.1% (w/w)) likely suffices to allow hydrolysis in presence of acid catalyst. Cellulose hydrolysis with [EMIM][OAc] is also consistent with prior reports: when treating with [EMIM][OAc] for 24 hours at 110° C., DP decreased from 1351 to 246 and from 3130 to 326 for poplar cellulose and filter paper cellulose, respectively (Gazit & Katz, supra), whereby the hydrolytic power of the IL has been ascribed to the generation of a proton (and a carbene) due to IL decomposition, which then likely catalyzes the hydrolysis of cellulose in presence of traces of water. Proton abstraction from the imidazolium by the basic [OAc] alongside carbene formation has been confirmed in prior studies both experimentally and through quantum-chemical calculations (Cremer et al., Chemistry—A European Journal 16 (30), 9018-9033, 2010; Ebner, Schiehser, Potthast & Rosenau, Tetrathedron Lett. 49 (51), 7322-7324, 2008; Gazit & Katz, supra; Rodriguez, Gurau, Holbrey & Rogers, Chem. Comm. 47(11), 3222-3224, 2011). Furthermore, carbene has been proposed to react with the reducing end of cellulose chains; this might be the case here since minute amounts of nitrogen were detected by EA in the IL-treated WR (Table 1) (Du & Qian, Carbohydrate research 346 (13), 1985-1990, 2011). Regardless of the specific mechanism, these analyses confirm that hydrolysis of cellulose amorphous regions has taken place during the IL cycles while the native crystallites microstructure remain unaltered as confirmed by WAXD.

Evidence of Acetylation of Cellulose during [EMIM][OAc] Treatment of Wood:

The FT-IR analysis of WR-2 hinted that acetyl groups were generated on the pulping products after the second IL treatment. To further assess the extent of acetylation, additional analyses were conducted on the CNCs. The results are shown in FIG. 5. The solid state NMR spectrum of CNCs confirms the predominance of cellulose in conjunction with acetyl groups identified through the carbonyl and methyl resonances, at 175 ppm and 20 ppm, respectively.

The degree of acetylation (DA) could be quantified for CNC-B using the back titration method (Kim, Nishiyama & Kuga, Cellulose, 9 (3-4), 361-367, 2002). DA was assessed as 0.28 ±0.01 (mol acetyl group/mol anhydroglucose) corresponding to ca. 9.3% acetylation of all hydroxyls. If the surface DA is estimated based on CNC structure and on the assumption that that only surface hydroxyl groups acetylate (Gu, Catchmark, Kaiser & Archibald, Carbohydrate Polymers 92(2), 1809-1816, 2013; Kim, Nishiyama & Kuga, supra), the surface DA is increased to a significant 22.3%. Likewise the CNC yield, initially measured form the mass balance, might now be adjusted for this chemical derivatization; we note that the overall cellulose degradation during the two pulping cycles is ˜23% and that the extraction yield of the CNC-B from the initial cellulose content becomes ˜44%.

Acetylation is expected to alter the thermal properties of CNCs, especially giving rise to a lower glass transition temperature between 120-160° C. (Sakellariou, Rowe & White, International Journal of pharmaceutics 27(2), 267-277, 1985) depending on the degree of acetylation. DSC thermogram evidenced a glass transition temperature at about 128.0° C. for the bleached CNCs (FIG. 6) confirming significant derivatization during pulping. The thermogravimetric analysis of CNCs (FIG. 7) also presented a broad first derivative degradation peak with an earlier shoulder peak at about 300° C. confirming the derivatization of cellulose and its resulting heterogeneous nature (Barud et al., Thermochimica Acta, 471(1), 61-69, 2008). Additionally, a lower degradation temperature (T_{d}) for CNCs compared to the original cellulose confirms hydrolysis (Staggs, Polymer 47(3), 897-906, 2006). Acetylation is also revealed by the good dispersibility of the nanocrystals solvents generally used for cellulose triacetate such as THF, ethanol, acetone, and mainly chloroform (FIG. 8).

### Example 2

### Bioresidue Comprising Mainly Lignin and Cellulose

A bioresidue comprising appr. 39.6 wt % of lignin, 50.9 wt % of cellulose and 9.5 wt % of extractives and obtained from a mixture of Norway spruce and pine was used in this example. The product had a crystallinity index of 57.1%. The extractives were removed by dewaxing in a conventional manner which resulted in a product comprising 43.8 wt % of lignin and 56.8 wt % cellulose having a crystallinity index of 62.1%.

The bioresidue was treated at 30° C. and 50° C. for 3-30 minutes using one cycle. After the mixing for the indicated time of mixing, the mixture was centrifuged at 12,000 rpm for 10 minutes (F156×100Y Multifuge, Thermo Scientific, USA), yielding a precipitate and a supernatant. The supernatant (Pulping Liquor) was decanted into a 200 mL Erlenmeyer flask. The precipitate (Wood Residue, WR)was washed three times with DMSO and then deionized water to remove residual dissolved wood and residual ionic liquid. It was subsequently oven-dried at 60° C. under vacuum overnight and kept in a desiccator until characterization.

Table 2 shows the results obtained for various treatment times. As can be seen, adjusting the treatment time and the treatment temperature allows to steer the recovery percentage, the degree of delignification and the cellulose recovery in accordance with the needs and the desired properties. The crystallinity index of the product increased when decreasing the treatment temperature and decreasing the tratment time with the ionic liquid.

TABLE 2

| | | | Delignifi- | Cellulose | |
|---|---|---|---|---|---|
| Temp. | Time | Recovery | cation | recovery | Crystallinity |
| (° C.) | (minutes) | (%) | (%) | (%) | index % |
| 50 | 30 | 20.4 | 84.3 | 24.0 | 12.6 |
| 30 | 30 | 49.3 | 84.7 | 75.8 | 28.6. |
| 30 | 20 | 54.3 | 79.0 | 80.3 | 42.6 |
| 30 | 10 | 59.9 | 72.4 | 85.0 | 54.3 |
| 30 | 5 | 60.4 | 68.5 | 83.0 | 67.5 |
| 30 | 3 | 70.2 | 59.9 | 92.1 | 70.6 |

The data show that treatment at very low temperatures and for short times yields a good recovery of the cellulose with good crystallinity index.

The cellulose nanocrystals obtained had a diameter of 2.4 nm (only slightly increased from 2.2 nm in the starting material) and were partially acetylated (degree of acetylation 4.2%) and had an aspect ratio of more than 50. The cellulose nanocrystals were coated with lignin (lignin content 25.4 wt %)

### Example 3

### Steam Explosion Combined with Ionic Liquid Treatment

Angelim Vermelho (Dinizia excelsa) wood obtained from the Amazonian rain forests was milled to a particle size of 150 pm and dewaxed for 8 hours using an ethanol:acetone:toluene mixture (1:1:4 volume ratio) in a soxhlet operating at 120° C. The dewaxed wood flour (ca. 9% mass loss) was then washed with hot water and oven-dried overnight at 60° C. under vacuum and kept in a vacuum desiccator until use.

For the extraction of cellulose nanocrystals, the wood was pretreated using steam explosion prior to the [EMIM][OAc] treatment. 4.0 g of Angelim Vermelho was soaked in a 400-mL beaker containing 100 mL of NaOH solution with a certain concentration (2% (w/w) or 5% (w/w)). The beaker was covered using Aluminum foil and placed inside an autoclave (Systec, Germany) containing deionized water. The setup was heated to a certain temperature (110° C. or 127° C.) to achieve a certain pressure (1.5 bar or 2.5 bar, respectively). Steaming was kept for a certain period of time (1 h or 2 h), after which the steam was released gradually (about 10-20 min). The beaker was taken out and the steam-exploded wood mixture was quenched with 200 mL of deionized water. The steam-exploded Angelim Vermelho was directly filtered off (to remove the dissolved wood) and was washed continuously with water then oven-dried under vacuum overnight at 60° C. Wood-0 and Wood-SE refer to the untreated and steam-exploded wood, respectively.

2.0 g of Wood-SE was stirred in open atmosphere with 40.0 g of [EMIM][OAc] pre-conditioned at 65° C. After 1.5 h of mixing, the mixture was centrifuged at 12,000 rpm for 10 minutes (F156×100Y Multifuge, Thermo Scientific, USA), to separate the dissolved and undissolved wood, yielding a precipitate (undissolved wood) and a supernatant (dissolved wood-+IL). The supernatant (dissolved wood+IL) was decanted into a 200 mL Erlenmeyer flask. The precipitated wood residue (undissolved wood) was washed multiple times with DMSO and then deionized water to remove any residual dissolved wood or residual ionic liquid. The residual lignin in the undissolved wood was removed by bleaching with 5% H2O2 at 60° C. for 2 hours, followed by washing with DI water. It was subsequently oven-dried at 60° C. under vacuum overnight and kept in a desiccator until characterization (Wood-SE-IL). Upon dispersing Wood-SE-IL in deionized water, and rapid sonication (30 seconds in ultrasonicater UW 2200, Bandelin Electronic, Germany), a turbid supernatant formed. The turbid supernatant was collected until no more turbidity was apparent, then subjected to further characterization as a dispersion and as a freeze-dried material. The steam explosion and [EMIM][OAc] treatment experiments were performed in duplicate to ascertain reproducibility. All reactants and wood residues were weighed using an analytical balance (Mettler-Toledo, Switzerland) with a precision of ±0.01 mg.

Wood chemical changes upon steam explosion and [EMIM][OAc] treatment were monitored with Fourier-Transform Infrared Spectroscopy (FT-IR) and X-ray Diffraction (XRD). For FT-IR analysis, KBr pellets were formed by mixing 2 mg of sample with 200 mg of potassium bromide (KBr). Spectra were collected in transmittance mode on a FT-IR spectrometer 65 (Perkin Elmer, USA) using 64 scans at a resolution of 2 cm−1. For XRD analysis, a Seifert 3003 TT X-ray diffractometer (General Electric, USA) using CuKα as a radiation source and operation at 40 kV and 30 mA was used in transmission mode. The intensities were collected at 2⊖ from 5 to 40. The crystalline structure was determined using Match! Software (version 1.11c) and the crystallinity index (Crl) was calculated according to Segal's method (Segal et al. 1959).

For a precise assessment of chemical changes upon both treatments, wood composition was determined using traditional wet chemistry approaches. Lignin content was measured with the method of Foster et al. with some modifications (Foster et al. 2010). The absorbance of the final solutions was determined using UV spectrophotometer TIDAS (J&M Analytik AG, Germany). The lignin content was then calculated based on a UV calibration curve previously constructed with wood-milled lignin solutions of known concentrations. The wood-milled lignin was obtained from Angelim Vermelho by the method of Björkman. A specific absorptivity of 22.25 L.g-1 was calculated from the calibration curve (Björkman 1956). Holocellulose and cellulose contents were determined following the method of Ona et al. (Ona et al. 1995). The cellulose obtained from the original wood (Wood-0) using this method (alkaline removal of hemicelluloses followed by bleaching) was used later as a reference for comparison purposes. It was referred to as original cellulose (CELL-0).

The collected turbid supernatant after SE and IL treatment was characterized for morphology, size distribution and surface properties with AFM, DSC, and contact angle. Briefly, for Atomic Force Microscopy (AFM): A droplet of a diluted sample from the supernatant of Wood-SE-IL dispersion in water was allowed to dry overnight on a fresh surface of mica. The sample was then observed in tapping mode with an atomic force microscope (Nanoscope III) equipped with a tube scanner (Veeco Santa Barbara, USA) using silicon tips (PPP-NCH, Nanoandmore,

Germany). The tips had a resonance frequency of 360 kHz and a spring constant of 50 N.m-1. The particle dimensions (height and length) were analyzed using Nanoscope Analysis software (version 1.40) for a population of 100 particles.

The degree of polymerization (DP) of the wood original cellulose (CELL-0) and the extracted cellulose nanocrystals (CNCs) were determined on duplicate samples after carbanilation with phenyl isocyanate (Hubbell and Ragauskas 2010). The gel permeation chromatography system PSS 1200 (Agilent Technologies, USA) was equipped with three styragel columns (PSS SDV 5 μm: 102, 103, and 104) and ultraviolet (1200 UV 254 nm) and refractive index (Knauer K-2301) detectors with tetrahydrofuran as a mobile phase (flow rate: 1.0 mL/min). The injection volume was 50 μL and the column temperature was 30° C. The calibration was performed using polystyrene standards (ReadyCal-Kit high, PSS-pskitr1h-04).

Degree of Acetylation (DA) was obtained with the back-titration method of Kim et al. (Kim et al. 2002).

Differential Scanning calorimetry (DSC): About 10 mg sample of the cellulose nanocrystals (CNCs) was placed in differential scanning calorimeter DSC 8500 (Perkin Elmer, USA) and heated to 20° C. at 10° C./min under nitrogen gas stream.

Contact Angle (CA) Measurement: The contact angle of the cellulose nanocrystals (CNCs) and the original cellulose (CELL-0) was measured using Digidrop equipment (GBX, France) by placing a water droplet volume of 4 μl on the surface followed by the required tangent procedure.

Table 3 shows the chemical composition and crystallinity index (% CrI) of Angelim Vermelho upon steam explosion. The standard deviation was less than 3% for all measurements. The chemical composition assumes 100 g of wood as a starting material.

TABLE 3

| SE Conditions | | | Composition and Crystallinity of Wood-SE | | | |
|---|---|---|---|---|---|---|
| NaOH | P | t | Cellulose | Hemicelluloses | Lignin | % CrI |
| (%) | (bar) | (h) | (g) | (g) | (g) | (%) |
| — | — | — | 47.6 | 19.4 | 33.0 | 41.5 |
| Water | 2.5 | 2 | 47.4 | 16.8 | 31.9 | 42.9 |
| 2 | 1.5 | 1 | 42.8 | 4.5 | 15.6 | 60.1 |
| 2 | 1.5 | 2 | 45.4 | 3.0 | 15.1 | 59.8 |
| 2 | 2.5 | 1 | 44.0 | 1.8 | 13.2 | 62.4 |
| 2 | 2.5 | 2 | 45.4 | 1.4 | 14.7 | 61.2 |
| 5 | 1.5 | 1 | 44.9 | 1.8 | 14.5 | 63.2 |
| 5 | 1.5 | 2 | 46.9 | 2.3 | 14.1 | 61.2 |
| 5 | 2.5 | 1 | 46.4 | 0.8 | 15.5 | 62.7 |
| 5 | 2.5 | 2 | 46.9 | 1.8 | 14.7 | 62.1 |

Table 4 shows the mass recovery (% MR) and crystallinity index (% CrI) of the steam-exploded wood after the IL treatment under various temperature and time conditions.

TABLE 4

| T (° C.) | t (min) | MR (%) | % CrI (%) |
|---|---|---|---|
| 65 | 90 | 3.9% ± 1.6 | — |
| 60 | 60 | 6.1% ± 2.7 | — |
| 50 | 60 | 21.8% ± 2.9 | 29.7% ± 4.2 |
| 40 | 30 | 43.8% ± 2.4 | 52.7% ± 3.3 |
| 30 | 15 | 77.1% ± 4.3 | 73.1% ± 2.7 |

FT-IR confirmed the chemical changes induced by the combined steam explosion and IL treatment. In contrast to the raw wood sample (Wood-0), the steam exploded wood (Wood-SE) had no detectable carbonyl vibration (1740 cm−1), confirming autohydrolysis of hemicelluloses upon steam explosion (Table 1). Minor drop in the intensity of the phenolics fingerprint at 1510 cm−1 and 1610 cm−1 was observed although ca. 50% delignification was evident upon steam explosion (Table 3). After IL treatment and the peroxide-based bleaching, almost complete delignification was evidenced by the quasi-absence of phenolics fingerprints (1510 cm−1 and 1610 cm−1). Additionally, acetylation by [EMIM][OAc] was evident.

The pulp after steam explosion and the IL treatment with [EMIM][OAc] (Wood-SE-IL) was highly dispersible in water. The dispersion was allowed to sediment and a turbid supernatant was collected and further analyzed. 87.4% of Wood-SE-IL was collected in the form of suspension. This represents ca. 52.7% of the cellulose content in the native wood.

AFM confirmed the presence of CNCs in the supernatant (Fig.3). The x-ray diffraction pattern of the freeze-dried supernatant confirms the native cellulose crystalline structure with the characteristic convoluted diffraction peaks at 2⊖ equal to 14.8°, 16.3°, 20.4°, 22.4° and 34.5°, which correspond to the crystallographic planes [−110], [110], [102], [200] and [004], respectively. No Cellulose II crystalline structure is present as its diffraction peak at 28 equal to 12° is absent. Crystallinity index increased from ca. 41.5±1.0% for the native wood to 75.6±1.0% for the nanocrystals of the Wood-SE-IL. This morphological analysis confirmed that native cellulose nanocrystals are also easily extracted from mildly steam exploded wood with the IL approach. Based on the particle size distribution obtained from the AFM image (FIG. 3), the nanocrystals were about 2.6 nm in width and about 225 nm in length. These nanocrystals are evidently thinner that those usually obtained from pulp and microcrystalline cellulose as pulping and acid hydrolysis lead to thickening of the cellulose crystallites.

These dimensions are consistent with the degree of polymerization of the CNCs measured at 394, viz. close to the level-off degree of polymerization of cellulose (Battista et al. 1956), and one order of magnitude lower than that of the original cellulose in wood at 3016. Cellulose hydrolysis has been reported to take place during steam explosion and [EMIM][OAc] treatment, separately. Cellulose hydrolysis using [EMIM][OAc] has been ascribed to the action of the proton generated from the imidazolium ring during the wood treatment. This molecular weight analysis, in addition to the x-ray diffraction results confirm that cellulose hydrolysis has taken place during the process, mainly targeting cellulose amorphous regions and keeping crystallites intact. Such a selective hydrolysis is the reason behind the liberation of the crystallites in the form of cellulose nanocrystals.

Combining steam explosion with a mild IL treatment is efficient at liberating cellulose nanocrystals from wood. Comparing the present results with Example 1, in which wood was treated with the same IL under harsher conditions twice (65, 1 h) in order to liberate CNCs, several observations are in order. In the SE/IL route, the steam explosion step allowed a milder IL treatment step (30° C. for only 15 min). Thus the SE/IL route appears overall milder than the route exclusively relying on the ionic liquid use.

The original IL/IL route has a higher CNC yield (58%) based on the cellulose content of wood. In the case of the SE/IL route, the yield decreases to approximately 45% of wood initial cellulose content. In other words, in this case there is a small loss of cellulose native crystals in the process. Overall both processes deliver CNCs in higher yields in comparison to those obtained with the traditional approaches of pulping and acid hydrolysis. Another advantage of the process is that the collection of CNCs in both cycles is done through liquid/liquid extraction thus circumventing the need for acid neutralization and CNC purification via the labor intensive and time consuming centrifugation/dialysis process. With both SE/IL and IL/IL routes the elimination of this bottleneck step significantly simplifies the entire production process and reduces production time.

Also interesting is the quality of the CNCs obtained from the SE/IL route in terms of dimensions, morphology and chemical attributes (Table 3). The resulting CNCs are thinner (2.6±1.4 nm) and somewhat longer (224±38) than CNCs obtained by the IL/IL method (˜65) or by the sulfuric acid hydrolysis method from pulp (20-40). The SE/IL CNCs thus display remarkable aspect ratios of 83±18. This aspect ratio is well over that reported previously for any other wood sources or even tunicate sources. These high aspect ratios stems from the average dimensions of these CNCs as slightly thinner and longer, even than those obtained with the I L/I L route.

1. A process for the production of cellulose nanocrystals directly from wood, grass or a bioresidue comprising mainly cellulose and lignin, comprising treating the wood, grass or the bioresidue with an ionic liquid at a temperature of 85° C. or less for a period of from 1 minutes to 12 hours.

2. The process in accordance with claim 1 wherein the treatment temperature is 75° C. or less.

3. The process in accordance with claim 1 wherein the treatment temperature is 70° C. or less.

4. The process according to claim 1, wherein the treatment time is of from 1 minute to 8 hours.

5. The process in accordance with claim 4 wherein the treatment time from 1 minute to 6 hours.

6. The process in accordance with claim 1 comprising at least two cycles of treatment of the wood or the grass with the ionic liquid.

7. The process in accordance with claim 1, wherein the ionic liquid is an imidazolium ionic liquid.

8. The process in accordance with claim 7 wherein the ionic liquid is 1-ethyl-3-methylimidazolium acetate ([EMIM][OAc]) or 1-butyl-3-methylimidazolium acetate ([BMIM][OAc]).

9. Cellulose nanocrystals prepared by the process of claim 1.

10. Cellulose nanocrystals according to claim 9 having a diameter of from 2 to 4 nm and an aspect ratio of from 20 to 100.

11. Cellulose nanocrystals in accordance with claim 9 comprising of from 5 wt % to 30 wt % of lignin coated onto the surface of the cellulose nanocrystals.

12. Cellulose nanocrystals in accordance with claim 9 having a degree of surface acetylation of from 3 to 40%.

13.-14. (canceled)

15. Cellulose nanocrystals according to claim 10 and having an aspect ratio of 40 to 90.

16. Cellulose nanocrystals in accordance with claim 10 comprising of from 5 wt % to 30 wt % of lignin coated onto the surface of the cellulose nanocrystals.

17. Cellulose nanocrystals in accordance with claim 10 having a degree of surface acetylation of from 3 to 40%.

18. Cellulose nanocrystals in accordance with claim 11 having a degree of surface acetylation of from 3 to 40%.

19. Cellulose nanocrystals in accordance with claim 9 having a degree of surface acetylation of from 4 to 30%.

20. Cellulose nanocrystals in accordance with claim 10 having a degree of surface acetylation of from 4 to 30%.

21. Cellulose nanocrystals in accordance with claim 11 having a degree of surface acetylation of from 4 to 30%.

22. Cellulose nanocrystals having a diameter of from 2 to 4 nm and an aspect ratio of from 20 to 100.
